(19) United States
(12) Patent Application Publication
(10) Pub. No.: US 2004/0131752 A1
(43) Pub. Date: Jul. 8, 2004

(54) Melt-resistant fudge article and methods of using same

(76) Inventors: Eric T. Best, Dublin, OH (US); Darryl R. Barwick, Marysville, OH (US); Lawrence A. Kibler, Marysville, OH (US)

Correspondence Address: WINSTON & STRAWN, PATENT DEPARTMENT, 1400 L STREET, N.W., WASHINGTON, DC, 20005-3502, US

(21) Appl. No.: 10/725,120

(22) Filed: Dec. 2, 2003

(30) Foreign Application Priority Data
Jan. 6, 2003 (JP) 2003-000112

(51) Int. Cl. A23G 3/00

(52) U.S. Cl. 426/660

(57) ABSTRACT

Melt-resistant fudge articles including a liquid fat component, such as an oil in an amount sufficient to minimize external adhesiveness of the article, a matrix of sugar crystals including a plurality of pores sized and shaped sufficiently to retain the liquid fat component by capillary attraction and being present in an amount sufficient so that the sugar crystals are temporarily bound to each other at temperatures up to about 40° C., and an emulsifier component to facilitate formation of the liquid fat component into droplets of at least substantially uniform size, wherein the article is substantially free of added moisture and has a glossy appearance resembling that of chocolate and wherein the article substantially retains its shape and appearance at temperatures up to about 40° C. yet is flowable at more elevated temperatures to facilitate processing thereof. Methods of forming a portion of a confectionery product with the melt-resistant fudge article at a temperature of at least about 50° C. to render the article flowable are also included.

### TECHNICAL FIELD

The present invention is directed to melt-resistant, preferably non-sticky, fudge articles and methods for making and using the same with confectionery products for consumption in tropical or hot climates.

### BACKGROUND ART

Conventionally manufactured chocolate consists of sugars, cocoa solids and protein (usually from milk) homogeneously dispersed in fats and fatty substances originating from cocoa butter. Chocolate analogues contain other vegetable fats. Often the continuous fat phase also contains dairy fat.

Since the fatty components form the continuous phase of chocolate, the storage stability and temperature behavior depend on the physical properties of the fat phase. Cocoa butter typically starts to soften at 28° C., with consequent loss of the mechanical strength of the chocolate. This means that at the high ambient temperatures frequently encountered in tropical countries, chocolate becomes sticky, even runny. It sticks to the wrapper and it falls apart when the wrapper is removed, leaving a semi-liquid mass that can only be eaten with a spoon if sanitary consumption thereof is desired. Enrobed chocolate products lose structural integrity under these conditions. Their contents leak and individual units stick together in the box. Another problem associated with the low melting point of cocoa butter is that of bloom. Bloom is caused by the separation of the melted cocoa butter on the surface of chocolate products at higher temperatures followed by its subsequent crystallization as the temperature falls. This gives an unpleasant grayish appearance to the product, reminiscent of mold. Repeated exposure to long hot and cold cycles is particularly likely to encourage blooming.

Those of ordinary skill in the art will be familiar with numerous water-based chocolate flavored coatings that avoid these problems by avoiding fat as the structural element. As a class, these materials, generally termed “icings”, have texture and flavor characteristics very different from chocolate itself.

For example, U.S. Pat. No. 4,296,141 discloses a chocolate flavored composition made from soy protein isolate as the emulsifying agent, combined with edible fats, sugars and other carbohydrates. The mixture is heated and extruded in a long strip or ribbon form for use as a confectionery coating.

U.S. Pat. No 6,251,448 discloses another approach in which hydrocolloids are used to produce unique in-mouth textures in confectionery coatings. However, in this patent, solid fats are disclosed to retain their structural functionality as the continuous phase, and the products melt in a similar manner to regular chocolate under elevated temperatures.

Thus, it is still desired to provide fudge articles, typically for use in connection with confectionery products, that provide an attractive, glossy appearance reminiscent of chocolate, provide a fudge-like texture, are non-sticky, retain structural integrity at elevated temperatures, and have a fat composition not susceptible to bloom.

### SUMMARY OF THE INVENTION

The invention encompasses a melt-resistant food article, e.g., fudge, that includes a liquid fat, typically a liquid oil, component in an amount sufficient to minimize external adhesiveness of the article, a matrix of sugar crystals and sugar glass particles including a plurality of pores, sized and shaped sufficiently to retain the liquid fat component by capillary attraction, and being present in an amount sufficient so that the sugar crystals are temporarily bound to each other at temperatures up to about 40° C., and an emulsifier component to facilitate formation of the liquid fat component into droplets of at least substantially uniform, or uniform, size. Preferably, the article is at least substantially free of added moisture and has a glossy appearance resembling that of chocolate and the article substantially retains its shape and appearance at temperatures up to about 40° C. yet is flowable at more elevated temperatures to facilitate processing thereof.

In one embodiment, the processing comprises enrobing a portion of a confectionery product with the article. In another embodiment, the portion enrobed is from about 50 percent to 99.9 percent of the surface area of the confectionery product. In another, the portion enrobed is the entire confectionery product. In one embodiment, the elevated temperature is at least about 45° C. In one embodiment, the sugar include one or more sugars, sugar alcohols, or a combination thereof. In a preferred embodiment, the sugar includes at least one of sucrose, glucose, fructose, lactose, lactulose, maltose, trehalose, invert sugar, corn syrup, honey, and the sugar alcohol includes at least one of sorbitol, mannitol, maltitol, xylitol, erythritol, lactitol, or a combination thereof. In a preferred embodiment, the sugar includes sucrose, corn syrup, and sorbitol.

In one embodiment, the article further includes non-fat milk, and wherein the liquid oil component includes coconut oil and soy oil. In a preferred embodiment, the article further includes a stabilizer component. In a preferred embodiment, the emulsifier component includes at least one monoglyceride- or mono-diglyceride. In another preferred embodiment, a stabilizer component including maltodextrin is present.

In one embodiment, the liquid fat component is an oil present in an amount of about 0.01 percent up to 30 percent of the article. If desired, a solid portion of a fat component may be present in the oil, such as one or more animal or vegetable fats, or a combination thereof, such that the solid fat content of the oil component is below about 10 weight percent at 20° C. and below about 1 weight percent at 40° C. In another embodiment, the article includes a stabilizer component in an amount sufficient to inhibit breakdown of the article. Preferred embodiments includes those where the stabilizer component includes one or more of polydextrose, maltodextrin, inulin, fructooligosaccharides, pectin, guar gum, locust bean gum, tara gum, fenugreek gum, mixed linkage β-glucans, oat bran, barley bran, methyl cellulose, carboxymethyl cellulose, microcrystalline cellulose, or a combination thereof.

In one embodiment, about 75 to 95 weight percent of the sugar is present as crystals, with the remainder of the sugar present predominantly as sugar glass particles, and about 5 to 25 weight percent liquid fat component are present in the article, with the remainder being the emulsifier component. In one embodiment, the sugar crystals have a mean size of about 15 to 25 μm. In another embodiment, the article has a water activity of about 0.44 to 0.52. The article can be a fudge coating.

The invention also encompasses a method of enrobing by providing a melt-resistant fudge article surprisingly including a liquid fat component in an amount sufficient to minimize external adhesiveness of the article and a matrix of sugar crystals and sugar glass particles comprising a plurality of pores sized and shaped sufficiently to retain the liquid fat component by capillary attraction and being present in an amount sufficient so that the sugar crystals and sugar glass particles are bound to each other at temperatures up to about 40° C., enrobing a portion of a confectionery product with the melt-resistant fudge article at a temperature of at least about 50° C. to render the article flowable, permitting the enrobed product to cool. Preferably, the cooling is sufficient so that the article has a glossy appearance resembling that of chocolate and substantially retains its shape and appearance at temperatures up to about 40° C., and an emulsifier component to facilitate formation of the liquid fat component into droplets of at least substantially uniform, or uniform, size. Preferably, the final article is substantially free of added moisture. In similar fashion, the melt-resistant fudge articles can be molded, such as into separate or scored confectionery bars, or onto the same as coatings. Each of the above-described embodiments is equally applicable with respect to the method of preparing the articles of the invention. In one embodiment, the permitting step provides for chilling the enrobed confectionery product to provide active cooling.

The invention also encompasses a method of providing a melt-resistant fudge article by combining liquid components comprising a liquid fat component in an amount sufficient to minimize external adhesiveness of the article, and a matrix of sugar crystals and “in situ” created sugar glass particles comprising a plurality of pores sized and shaped sufficiently to retain the liquid fat component by capillary attraction and preferably being present in an amount sufficient so that the sugar particles are bound to each other at temperatures up to about 40° C., at a temperature of at least about 50° C. to form a liquid mixture; then combining one or more solid components comprising an emulsifier component to facilitate formation of the liquid fat component into droplets of at least substantially uniform, or uniform, size so as to form a fudge article mixture; and reducing the temperature of the fudge article mixture below 40° C. to form a solid, melt-resistant fudge article. Preferably, the final article is substantially free of added moisture. The solid components can be combined to each other first and then combined with the liquid mixture, or the solid components can be added sequentially to the liquid mixture, to form the melt-resistant fudge article.

In a preferred embodiment, the method of providing articles further includes shaping the melt-resistant fudge article at a temperature of at least about 55° C. to render the article flowable before reducing the temperature thereof, and disposing the flowable article adjacent a portion of a confectionery product so that it solidifies and adheres thereto after the temperature reduction below 40° C. to provide the confectionery product with a glossy appearance resembling that of chocolate. In another embodiment, at least one solid component is combined with the liquid mixture to form the fudge article mixture.

The invention also encompasses coated confectionery articles, which include a confectionery article, e.g., one or more sugar wafers, frozen confectionery products (ice cream, water ice, etc.), chocolate or analogues thereof, or the like, enrobed with the melt-resistant fudge article.

### BRIEF DESCRIPTION OF THE DRAWINGS

Further features and advantages of the invention can be ascertained from the following detailed description that is provided in connection with the drawing(s) described below:

FIG. 1 shows an arrow pointing to a microscopic pore within a sugar matrix of the invention, within which pore a portion of the liquid fat component resides and is retained primarily by capillary action.

### DETAILED DESCRIPTION OF THE PREFERRED EMBODIMENTS

This invention discloses formulations for the production of couvertures, or articles, that typically resemble chocolate for confectionery products. The articles typically have a glossy appearance and fudge-like texture. The melt-resistant food articles, typically fudge articles, of the invention include a liquid fat component in an amount sufficient to minimize external adhesiveness of the article, and a matrix of sugar crystals and sugar glass particles, comprising a plurality of pores sized and shaped sufficiently to retain the liquid fat component by capillary attraction. In one embodiment, the sugar crystals and sugar glass particles are present in an amount sufficient so that the sugar particles are temporarily bound to each other at temperatures up to about 40° C. The final articles are substantially free of added moisture and have a glossy appearance resembling that of chocolate, and the final article substantially retains its shape and appearance at temperatures up to about 40° C. yet is flowable at more elevated temperatures to facilitate processing thereof.

The invention provides a range of formulations whereby the structural integrity of the article depends on the presence of a sugar matrix. The article therefore retains its shape and remains non-sticky at the elevated temperatures frequently encountered in tropical climates, i.e., at temperatures up to about 40° C. The choice of oil component helps minimize or avoid adhesiveness, i.e., increases the non-stickiness, and helps provide the desired in-mouth textural characteristics without a propensity to bloom. The articles of the invention can be made to resemble chocolate, but they can also be made in a variety of other colors and flavors, limited only by the ingenuity of those of ordinary skill in the art.

The liquid component of the invention is typically present as oil. Optionally, this liquid fat-based component can include or be formed from one or more lipids. Any suitable oil or fat of vegetable or animal origin, or blends thereof that is available to those of ordinary skill in the art may be included. Surprisingly, the oils or fats in the component should be liquid, but may contain a portion of solids so as long as the solid fat content is no more than about 10 weight percent at 20° C. and no more than about 1 weight percent at 40° C. The liquid oil component, or fat or lipid component, preferably includes coconut oil, soy oil, or a mixture thereof. More preferably, the liquid fat component is a liquid oil component that includes both coconut and soy oils. The liquid fat component can add up to and include about 0.1 to 30 weight percent, preferably about 1 to 25 weight percent, of the article composition. In one more preferred embodiment, the liquid fat component is present in about 5 to 20 weight percent of the article.

The liquid fat is typically present in the articles of the invention in the form of droplets within the sugar crystal and sugar glass matrix. Droplets are typically sized at about 10 to 40 μm, preferably from about 20 to 30 μm volume average diameter. It is preferred that substantially all, i.e., at least 80 percent, more preferably at least 95 percent, of the droplets fall within the size range. Preferably, at least about 99 percent of the droplets fall within the size range. These substantially uniformly, or uniformly, sized liquid fat droplets are typically achieved at least in part by selection of type and amount of liquid fat, e.g., oil, and the selection and type of emulsifier component.

The sugar matrix provides a structure for the article to contain the liquid fat component. The sugar matrix includes a plurality of pores sized and shaped sufficiently to retain the liquid fat component by capillary attraction, even when the oil is wholly in the liquid state at elevated temperatures. This matrix can include any sugar or sugar alcohol, or a mixture thereof, available to those of ordinary skill in the art that is capable of being formed into a pore-containing matrix and retaining structural adhesion between the sugar particles. Particularly suitable sugar particles can be provided by one or more of sucrose, corn syrup, maltose, trehalose, glucose, fructose, lactose, invert sugar, honey, sorbitol, glycerol, erythritol, mannitol, maltitol, xylitol, or the like, or a mixture thereof. In one preferred embodiment, the sugar matrix includes sucrose, corn syrup, and a sugar alcohol. In another embodiment, suitable sugar particles can be obtained by including sucrose, sorbitol, corn syrup, or any combination thereof. A more preferred embodiment is where the sugar matrix includes sucrose, corn syrup and sorbitol. Various other suitable combinations can be envisioned based on the teachings herein. The sugar matrix pore size typically ranges from about 10 to 100 μm, preferably from about 20 to 80 μm.

In one embodiment, the sugar matrix is typically present in an amount relative to the liquid fat component that is sufficient so that the sugar crystals are temporarily bound to each other at temperatures up to about 40° C. The sugar matrix is typically present at about 45 to 85 weight percent, preferably about 50 to 80 weight percent, and more preferably about 55 to 75 weight percent, of the article. For example, the sugar matrix can include one or more sugars in an amount up to about 40 to 60 weight percent of the composition and one or more sugar alcohols in an amount up to about 4 to 20 weight percent, preferably from about 5 to 10 weight percent, of the composition. Sugar alcohols (polyols) can have a laxative action. For sorbitol, e.g., the laxative threshold is 50 g/day. Consequently, with sorbitol added at 10 percent, a typical consumer can eat 1 kg of candy (with a pick-up weight of article of 50%) before exceeding the laxative threshold.

The sugar matrix typically contains at least about 60 percent crystalline sugar, preferably at least about 75 percent crystalline sugar, and more preferably at least about 80 percent crystalline sugar, held together by sugar glass particles. The sugar crystal sizes should typically have a mean size of about 10 μm to 50 μm, preferably about 15 μm to 30 μm. In one preferred embodiment, the crystals have a narrow size distribution such that their diameter is from about 16 to 24 μm. The material thus has pores sized sufficiently small to retain the liquid fat component at least primarily by capillary attraction.

Without being bound by theory, it is believe that the “sugar glass” or glassy sugar, or the combination of such sugar with crystalline sugar, rather than crystalline sugar alone, provides the surprising characteristics of the articles of the present invention. Sugar glass fractures more easily upon consumption, and dissolves even faster, than an equivalent crystalline sugar structure. Thus, the ratio of sugar glass to crystalline sugar permits increased control of the dissolution characteristics while being consumed, i.e., “in-mouth.” This dissolving effect is different from the disintegrating effect caused by gum swelling that breaks the coating mass into tiny fragments during consumption. The glassy sugar forms upon cooling or drying the mass of the invention to a point where the viscosity is sufficiently high that the sugar molecules can no longer adopt a regimented, ordered layout to form crystalline sugar, even though this is ultimately a lower energy state than the glassy form. Thus, the molecules of sugar glass are random rather than ordered, and glassy rather than crystalline. Since the sugar glass molecules have less energy than ordered sugar crystal molecules, the sugar glass binding energy is lower and therefore, glassy sugar requires less energy to dissolve than sugar crystals. As a result, it is believed that more rapid dissolution of the coatings of the invention during consumption can occur using a higher, desired ratio of sugar glass compared to sugar crystals.

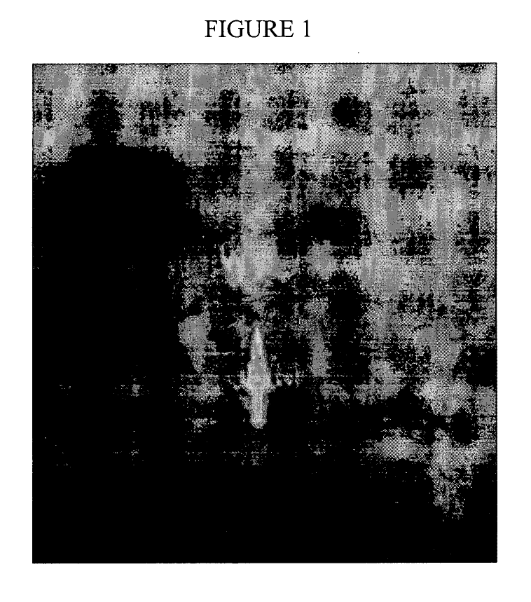

In FIG. 1, the pore size is illustrated by an arrow pointing to a microscopic pore that is approximately 30 microns across and is present within the sugar matrix. The liquid fat component is an oil that resides within a pore, and is retained primarily by capillary action.

The article optionally, but preferably, also includes a stabilizer component, an emulsifier component, or more preferably, both. The emulsifier component is preferably present in the fudge article to facilitate formation of at least substantially uniform, or uniform, liquid fat droplet sizes. The emulsifier component typically includes a monoglyceride, mono-diglyceride, or a mixture thereof. The stabilizer component preferably includes maltodextrin. The maltodextrin can be wholly or partly substituted with other polysaccharides that include (but are not limited to) polydextrose, microcrystalline cellulose, mixed linkage β-glucans, oat bran, barley bran, inulin, psyllium, fructooligosaccharides, pectin, guar gum, locust bean gum, tara gum, fenugreek gum, methyl cellulose, carboxymethyl cellulose, or the like, or any mixture thereof. The choice of stabilizer component is limited only by its ability to facilitate retention of the liquid fat component within the sugar matrix during processing.

An exemplary article of the present invention includes a sugar matrix formed from sugar, corn syrup, and sorbitol; non-fat milk; and a liquid fat component including coconut and soy oils. It is preferably stabilized with maltodextrin as the stabilizer component and further includes an emulsifier component.

In certain embodiments, the article can include cellulose fibers present. These can be deliberately included or can be present as a result of selecting certain components for the sugar matrix, liquid fat component, emulsifier component, or stabilizing component. While any suitable size is acceptable, if fibers are present they are typically about 300 to 600 μm long, preferably about 400 to 550 μm long, as well as about 5 to 50 μm wide, preferably about 12 to 20 μm wide at their thickest part.

The water content of the article, or couverture, is typically low. The water activity should be from about 0.42 to 0.54. Measured water activities (a_{w}) for different types of articles of the invention ranged from about 0.47 to 0.49—well below the minimum a_{w} for microbial growth. These low water activities also mean that the article is suitable for articles including wafer products, where significant water activity is likely to render the wafer content undesirably soggy. The water activity of a typical wafer is around 0.55—consequently there is little possibility of quality loss on storage of such products resulting from migration of water from the article of the invention into a conventional wafer.

At temperatures over about 60° C., and possibly even as low as about 55° C. or 50° C., the article mixture is free flowing and is suitable for making enrobed confectionery products using conventional enrobing technology. In one embodiment, the temperature above which the article becomes flowable for ease of processing is about 70° C., while in another the temperature is about 74° C. Although enrobing is a preferred method of applying the articles of the invention, molding and other conventional processing techniques are within the scope of the invention. The formulation also has the advantages of being fairly low cost since no cocoa components are required, as well as the potential for introduction of dietary fibers as part of the stabilizer system, with consequent health benefits to consumers. Also, articles of the invention are not gritty, since the sugar crystal size is sufficiently small to avoid consumer detection during handling or consumption of the articles.

The melt-resistant fudge articles of the invention preferably include some or all of the following beneficial features: melt resistance, adhesion resistance, soft mouthfeel, and bloom resistance/glossy appearance. These can be surprisingly and unexpectedly achieved by the method of the invention. Without wishing to be bound by theory, but in a manner that can be readily observed microscopically by those having ordinary skill in the art, the following is believed to happen during preparation of the articles of the invention.

1. The crystal sugars present only partially liquefy in the formation process, and so create the appropriate size of residual crystals. The liquid fat, e.g., oil, is emulsified to a specific droplet size and becomes dispersed between these crystals.

2. Upon preliminary stages of cooling, owing to an increased viscosity, the sugar that went into liquid form does not re-crystallize upon the existing crystals as would normally be expected. Rather, the emulsified and hence well-dispersed fluid droplets of liquid sugar form soft, plasticized glass that then “glues” or “cements” the sugar crystals sufficiently together around the liquid fat droplets.

3. Then, this softer sugar glass itself solidifies into particles and some shape modification simultaneously occurs to the interstices owing to resultant changes to surface tension effects. The interstices with the mass thus become polyhedral pores that facilitate holding the liquid fat component, e.g., oil, in place by capillary attraction.

4. As a result, extremely fluid fat, such as oil (not previously expected to be suitable for inclusion in melt resistance products, particularly in such high amounts as described herein), that might be expected to “leak” from the structure, i.e., escape from the pores and eventually the entire mass, actually is at least substantially held within.

One or more of the following surprising and unexpected benefits therefore can be achieved when melt-resistant fudge articles are prepared according to the invention described herein:

a) The melt-resistance of the resultant articles is now provided primarily by the sugar crystal structure. This is an unexpected solution to the problem of attempting to achieve suitable melt-resistance in edible articles such as confectioneries, because including liquid fats or oils would normally be expected to cause problems of a mass that suffers from both adhesiveness and hardness in the mouth. See item (c).

b) Adhesion resistance can now be provided to articles of the invention by lubrication from the liquid fat component, e.g., fluid oil. The fluid fat or oil that resides at the open ends of the pores at the very outside edges of the final article can provide a trace of surface lubrication to facilitate adhesion resistance, particularly to wrapping materials. Had too much solid fat been incorporated (use of solid fat is what is normally used to provide melt resistance), then the degree of lubrication would have been undesirably minimized or prevented.

c) The anticipated hardness of a set sugar in the mouth is also unexpectedly and beneficially minimized or avoided by the ready solubility of the sugar glass, and the fact that the sugar glass is predominantly present in small and well-dispersed particles. The hard sugar crystals themselves are also very small and they do not typically join or grow into each other in the cooling process, which is expected when cooling a regular fluid sugar mass. The tiny well dispersed particles of glassy sugar “glue” are comprised of disordered molecules that have solidified under a viscosity that is too high to permit them to adopt a more ordered configuration. Therefore, in the sugar glass, the expected high level of bonding forces that typically forms in a sugar crystal is believed to be minimized or avoided.

Therefore in the mouth, the sugar glass dissolves far more easily and rapidly than a similar crystalline structure. Also, the speed of solution is accelerated by the small size of the glass deposits. Further, the sugar crystals that are ultimately released and present in the final articles are controlled to be of a size that is sufficiently small that they cannot typically be detected as grittiness by consumers of the articles. Additionally, the release of sufficiently fluid fat or oil (not the usual hard fat used for melt resistance) from the mass facilitates or provides instant lubrication, i.e., avoids stickiness or adhesiveness. The combination of two or more of these effects surprisingly and unexpectedly can provide the surprisingly soft mouthfeel to articles of the present invention.

The bloom resistance ability is another unexpected feature that can be achieved by including a liquid fat or oil inside pores. Bloom is typically a result of solid fat melting and migrating to the surface of the finished article over extended periods of time in chocolate and chocolate analogue products, where the solid fat re-sets on the surface as a whitish deposit. Conventional solutions to this problem include using harder fats, or those with higher melting points, to resist melting. The surprising and unexpected inclusion of a liquid fat or oil inhibits or prevents the liquid fat or oil from setting on the surface of the article. The creation of the appropriately sized pores within the structure, as further described herein in accord with the invention, holds a majority of the liquid fat or oil within, e.g., by capillary action, which inhibits migration of the fat or oil to the surface. In fact, the trace of liquid fat or oil that does reach the surface gives a desirable sheen or glossy appearance to the surface.

### EXAMPLES

The following examples are not intended to limit the scope of the invention, but merely to illustrate representative possibilities concerning the present invention.

### Example 1

### Tropicalized Milk Article of the Invention

A couverture was prepared according to the present invention with the following composition:

| Ingredient | % (w/w) |
|---|---|
| Powdered sugar | 49.3 |
| Spray dried skim milk powder | 10.7 |
| Tapioca maltodextrin (N-Zorbit) | 2.7 |
| Corn syrup, 42DE | 8.2 |
| Liquid sorbitol (67% sorbitol) | 12.7 |
| Water | 2.7 |
| 51-25 coconut oil | 11.1 |
| Soybean oil | 2.3 |
| Mono-diglyceride (Cremodan ® Super) | 0.4 |

The liquid ingredients, including the corn syrup, were blended and emulsified at 60° C. The solid ingredients were then added, using a planetary mixer. An article of the invention was produced.

### Example 2

### Tropicalized “Fudge” Article of the Invention

A couverture was prepared according to the present invention with the following composition:

| Ingredient | % (w/w) |
|---|---|
| Powdered sugar | 47.7 |
| Spray dried skim milk powder | 8.7 |
| Cocoa 10/12% fat | 5.2 |
| Tapioca maltodextrin (N-Zorbit) | 2.7 |
| Corn syrup, 42DE | 8.5 |
| Liquid sorbitol (67% sorbitol) | 13.0 |
| Water | 2.8 |
| 51-25 coconut oil | 11.4 |
| Soybean oil | 2.3 |
| Mono-diglyceride (Cremodan ® Super) | 0.4 |

The liquid ingredients, including the corn syrup, were blended and emulsified at 60° C. The solid ingredients were then added, using a planetary mixer. An article of the invention was produced.

### Example 3

### Test of Liquid Fat Component Retention Within Article

Measurements were made of the leakage of the liquid fat component using the standard “fat stain test.” Equal weights of test material of a conventional compound chocolate and an article according to the invention are placed on absorbent paper and held at a suitable elevated temperature (in this case 40° C.) for 24 hours. The area of fat stain was then measured. In a typical experiment, the area of fat stain from the article was 0.02 cm² compared with 0.33 cm² from an equal weight of a compound chocolate. Thus, the article surprisingly and unexpectedly retains substantially all or all of its liquid fat component within the sugar matrix. It therefore does not soil the fingers at the elevated temperatures encountered by consumers in tropical countries. Nonetheless, the article has the benefit of an oily sheen and an oily feel when handled, and does not stick to wrapping material which consumers desire in chocolate analogue products. This sheen imparts a surface gloss resembling high quality chocolate.

### Example 4

### Coated Wafers According to the Invention

An article was prepared according to the invention and used to enrobe a conventional sugar wafer. The wafer center was about 78 weight percent, while the article was about 22 weight percent of the coated article. The wafers remained crisp after enrobement and storage for seven (7) weeks under ambient conditions.

The term “about,” as used herein, should generally be understood to refer to both numbers in a range of numerals. Moreover, all numerical ranges herein should be understood to include each whole integer within the range.

The term “non-sticky,” as used herein, refers to a final product that is sufficiently smooth and/or sufficiently solid so that no detectable portion of the product will remain on the product packaging when the product is removed therefrom, and preferably non-sticky refers to products that consumers can also readily hold with their hands for consumption without any significant residue being left behind on the consumer's hands.

The term “temporarily,” as used herein, means less than about a month, and more typically less than about 2 weeks. “Substantially free,” as used herein, means less than about 5 weight percent, preferably less than about 2 weight percent, and more preferably less than about 0.1 weight percent.

The term “melt-resistant,” as used herein, typically refers to fudge articles according to the invention that are essentially free of flowability above about 40° C., preferably above 40° C. “Essentially free” means that less than about 3 weight percent, preferably less than about 1 weight percent, and more preferably less than about 0.01 weight percent, of the fudge article is flowable at 40° C. or below. Preferably, the fudge articles are completely free of flowability, except possibly for trace amounts of flowable liquids, below these noted temperatures to provide shape retention and heat resistance thereto according to the invention.

The term “substantially,” as used herein with respect to the language “substantially retains its shape,” refers to the shape retention index. Typically, an article of the invention retains at least about 80 percent of its shape, preferably at least about 90 percent of its shape, and more preferably at least about 95 percent of its shape, even when dropped 18 inches.

The term “liquid oil component” as used herein can include any amount of fat content so long as the overall component is still a liquid, and therefore should be understood to cover liquid fat components as well.

Although preferred embodiments of the invention have been described in the foregoing description, it will be understood that the invention is not limited to the specific embodiments disclosed herein but is capable of numerous modifications by one of ordinary skill in the art. It will be understood that the materials used and the chemical details may be slightly different or modified from the descriptions herein without departing from the methods and compositions disclosed and taught by the present invention.

What is claimed is:

1. A melt-resistant fudge article which comprises:
a liquid fat component in an amount sufficient to minimize external adhesiveness of the article;
a matrix of sugar crystals comprising a plurality of pores sized and shaped sufficiently to retain the liquid fat component by capillary attraction and with sugar glass being present in an amount sufficient to temporarily bind the sugar crystals to each other at temperatures up to about 40° C.; and
an emulsifier component to facilitate formation of the liquid fat component into droplets of at least substantially uniform size,
wherein the article is substantially free of added moisture and has a glossy appearance resembling that of chocolate, and wherein the article substantially retains its shape and appearance at temperatures up to about 40° C. yet is flowable at more elevated temperatures to facilitate processing thereof.

2. The melt-resistant fudge article of claim 1, wherein the processing comprises an enrobing process whereby a portion of a confectionery product is enrobed with the article.

3. The melt-resistant fudge article of claim 1, wherein the elevated temperature is at least about 45° C.

4. The melt-resistant fudge article of claim 1, wherein the sugar crystals comprise one or more sugars, sugar alcohols, or a combination thereof.

5. The melt-resistant fudge article of claim 1, wherein the sugar crystals comprise one or more of sucrose, glucose, fructose, lactose, lactulose, maltose, trehalose, invert sugar, corn syrup, honey, sorbitol, mannitol, maltitol, xylitol, erythritol, lactitol, or any combination thereof.

6. The melt-resistant fudge article of claim 1, wherein the sugar crystals comprise sucrose, corn syrup, sorbitol, or a combination thereof.

7. The melt-resistant fudge article of claim 4, further comprising non-fat milk, and wherein the liquid fat component comprises coconut oil and soy oil.

8. The melt-resistant fudge article of claim 4, further comprising a stabilizer component.

9. The melt-resistant fudge article of claim 8, wherein the stabilizer component comprises maltodextrin.

10. The melt-resistant fudge article of claim 1, wherein the emulsifier component comprises any combination of monoglycerides, mono-diglycerides, or both.

11. The melt-resistant fudge article of claim 1, wherein the liquid fat component is an oil that is present in an amount of about 0.01 percent up to 30 percent of the article, and wherein a solid portion of the fat comprises one or more animal or vegetable fats, or a combination thereof, such that the solid fat content is below about 10 weight percent at 20° C. and below about 1 weight percent at 40° C.

12. The melt-resistant fudge article of claim 1, further comprising a stabilizer component in an amount sufficient to inhibit breakdown of the article which stabilizer component comprises one or more of polydextrose, maltodextrin, inulin, fructooligosaccharides, pectin, guar gum, locust bean gum, tara gum, fenugreek gum, mixed linkage β-glucans, oat bran, barley bran, methyl cellulose, carboxymethyl cellulose, microcrystalline cellulose, or a combination thereof.

13. The melt-resistant fudge article of claim 1, wherein about 75 to 95 weight percent of sugar is present as crystals and about 5 to 25 weight percent liquid fat component are present, with the remainder being the emulsifier component.

14. The melt-resistant fudge article of claim 1, wherein the sugar crystals have a mean size of about 15 to 25 μm.

15. The melt-resistant fudge article of claim 1, wherein the article has a water activity of about 0.44 to 0.52 and the melt-resistant article is a coating.

16. A coated confectionery article, which comprises a confectionery product having at least a portion enrobed with the melt-resistant fudge article of claim 1.

17. A method of enrobing which comprises:
providing a melt-resistant fudge article that comprises a liquid fat component in an amount sufficient to minimize external adhesiveness of the article, a matrix of sugar crystals comprising a plurality of pores sized and shaped sufficiently to retain the liquid fat component by capillary attraction and being present in an amount sufficient so that the sugar crystals are bound to each other at temperatures up to about 40° C., and an emulsifier component to facilitate formation of the liquid fat component into droplets of at least substantially uniform size;
enrobing a portion of a confectionery product with the melt-resistant fudge article at a temperature of at least about 50° C. so that the article is flowable; and
permitting the enrobed product to cool sufficient so that the article has a glossy appearance resembling that of chocolate and substantially retains its shape and appearance at temperatures up to about 40° C., wherein the article is substantially free of added moisture.

18. The method of claim 17, wherein the permitting comprises chilling the enrobed confectionery product to provide active cooling.

19. The method of claim 17, wherein the providing comprises an article selected to include about 5 to 15 weight percent liquid fat component with about 80 to 95 weight percent of the sugar as crystals, with the remainder being the emulsifier component.

20. A method of providing a melt-resistant fudge article which comprises:
combining liquid components comprising a liquid fat component in an amount sufficient to minimize external adhesiveness of the article, and a matrix of sugar crystals comprising a plurality of pores sized and shaped sufficiently to retain the liquid fat component by capillary attraction and being present in an amount sufficient so that the sugar crystals are bound to each other at temperatures up to about 40° C., at a temperature of at least about 50° C. to form a liquid mixture;
then combining one or more solid components comprising an emulsifier component to facilitate formation of the liquid fat component into droplets of at least substantially uniform size so as to form a fudge article mixture;
reducing the temperature of the fudge article mixture below 40° C. to form a solid, melt-resistant fudge article, wherein the article is substantially free of added moisture.

21. The method of claim 20, further comprising:
shaping the melt-resistant fudge article at a temperature of at least about 55° C. to render the article flowable before reducing the temperature thereof; and
disposing the flowable article adjacent a portion of a confectionery product so that it solidifies and adheres thereto after the temperature reduction below 40° C. to provide the confectionery product with a glossy appearance resembling that of chocolate.

22. The method of claim 20, wherein at least one solid component is combined with the liquid mixture to form the fudge article mixture.
